(19) United States
(12) Patent Application Publication
(10) Pub. No.: US 2012/0198227 A1
(43) Pub. Date: Aug. 2, 2012

(54) CIPHER KEY GENERATION IN COMMUNICATION SYSTEM

(76) Inventors: Alec Brusilovsky, Naperville, IL (US); Lu Tian, Plano, TX (US); Yong Zhao, Plano, TX (US)

(21) Appl. No.: 13/192,957

(22) Filed: Jul. 28, 2011

Related U.S. Application Data
(60) Provisional application No. 61/388,404, filed on Sep. 30, 2010.

(51) Int. Cl. H04L 9/00

(52) U.S. Cl. 713/150

(57) ABSTRACT

Techniques are disclosed for generating a cipher key such that an encryption algorithm typically usable in accordance with a first security context can be used in accordance with a second security context. In one example, the first security context is a UMTS security context and the second security context is a GSM security context.

The present application claims priority to the U.S. provisional patent application identified as Ser. No. 61/388,404, filed on Sep. 30, 2010, and entitled “The Support of GSM Encryption A5/4 in the GSM Security Context,” the disclosure of which is incorporated by reference herein in its entirety.

### FIELD OF THE INVENTION

The present invention relates generally to communication security and, more particularly, to techniques for generating a cipher key such that an encryption algorithm typically usable in accordance with a first security context (e.g., UMTS) can be used in accordance with a second security context (e.g., GSM).

### BACKGROUND OF THE INVENTION

It is known that the Universal Mobile Telecommunications System (UMTS) is a third generation communication network technology that was developed by 3GPP (3rd Generation Partnership Project) to improve upon its predecessor the Global System for Mobile Communication (GSM). A UMTS network utilizes a UMTS Terrestrial Radio Access Network (UTRAN) as the air interface (radio access technology) for mobile stations accessing a UMTS network. A GSM network utilizes a GSM EDGE Radio Access Network (GERAN) as the air interface for mobile stations accessing a GSM network.

Given the various network protocols and radio access technologies that are available, and given the fact that communication systems tend to be hybrid in nature (e.g., use two or more radio access technologies or network protocols) while one or more newer communication standards gradually replace one or more older communication standards, it is known that manufacturers of mobile equipment (e.g., smartphones, portable computers, etc.) design their mobile equipment with the capability to operate via multiple radio access technologies and network protocols. Thus, certain mobile equipment is known to have multi-mode capability so as to be able to selectively operate, for example, in one of two or more modes such as, by way of example, a GSM communication mode or a UMTS communication mode. Thus, as the mobile device roams in the communication system, it can access the system via whatever mode or modes are available in a given geographic area.

However, while improved security approaches are developed and implemented for newer communication modes (e.g., UMTS), such improved security approaches tend not to be available when a hybrid mobile device is operating in an older communication mode (e.g., GSM).

### SUMMARY OF THE INVENTION

Embodiments of the invention provide techniques for generating a cipher key such that an encryption algorithm typically usable in accordance with a first security context can be used in accordance with a second security context. In one example, the first security context is a UMTS security context and the second security context is a GSM security context.

For example, in one aspect of the invention, a method comprises generating a first cipher key of an encryption algorithm for use by at least one computing device in a communication network to exchange encrypted communications with at least another computing device in the communication network. The first cipher key is associated with a security context of a first communication mode and is generated from a second cipher key associated with a security context of a second communication mode. The first cipher key is usable in the encryption algorithm in accordance with the second communication mode.

In one or more embodiments, the security context of the first communication mode is a Universal Mobile Telecommunications System (UMTS) security context, the security context of the second communication mode is a Global System for Mobile Communication (GSM) security context, the encryption algorithm is an A5/4 encryption algorithm, the first cipher key comprises a 128-bit cipher key, and the second cipher key comprises a 64-bit cipher key.

Further, in one or more embodiments, the generating step further comprises the at least one computing device: obtaining the second cipher key; generating a pair of key components from the second cipher key; and generating the first cipher key from the pair of key components. The pair of key components comprise an integrity key (IK) and another cipher key (CK).

Still further, in one or more other embodiments, the generating step further comprises the at least one computing device: obtaining the second cipher key; and generating the first cipher key by concatenating one instance of the second cipher key to another instance of the second cipher key.

Advantageously, embodiments of the invention allow an improved security approach to be used in an older generation communication protocol.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a communication network architecture in which one or more embodiments of the invention may be implemented.

FIG. 2 illustrates a flow diagram of a methodology for generating a cipher key.

FIG. 3A illustrates a flow diagram of a methodology for generating a cipher key according to a first embodiment of the invention.

FIG. 3B illustrates a flow diagram of a methodology for generating a cipher key according to a second embodiment of the invention.

FIG. 4A illustrates a flow diagram of a methodology for generating a cipher key according to a third embodiment of the invention.

FIG. 4B illustrates a flow diagram of a methodology for generating a cipher key according to a fourth embodiment of the invention.

FIG. 5A illustrates a flow diagram of a methodology for generating a cipher key according to a fifth embodiment of the invention.

FIG. 5B illustrates a flow diagram of a methodology for generating a cipher key according to a sixth embodiment of the invention.

FIG. 6 illustrates a flow diagram of a methodology for generating a cipher key according to a seventh embodiment of the invention.

FIG. 7 illustrates a hardware architecture of a part of a communication system and computing devices suitable for implementing one or more of the methodologies and protocols according to embodiments of the invention.

### DETAILED DESCRIPTION OF PREFERRED EMBODIMENTS

Principles of the present invention realize the need to secure communications associated with hybrid communication systems. In the embodiments to follow, a hybrid GSM/UMTS system (2^{nd} generation or 2G system/3^{rd} generation or 3G system) will be used to illustratively describe the security techniques and mechanisms of the invention. However, it is to be understood that the principles of the present invention are not limited to hybrid communication systems with GSM and UMTS communication modes but rather are more generally suitable for a wide variety of other hybrid communication systems in which it would be desirable to allow an improved security approach to be used in an older generation communication protocol.

As used herein, the phrase “hybrid communication system” generally refers to a communication system that supports two or more communication modes. “Communication mode” (or simply “mode”) generally refers to an operation mode that supports a particular radio access technology and/or network protocol that is used to provide communication and access features for a particular type of communication network. By way of example, communication modes that are part of an illustrative hybrid communication system described herein include a GSM communication mode and a UMTS communication mode.

Further, as used herein, the phrase “security context” generally refers to a communication environment for which one or more security definitions exist.

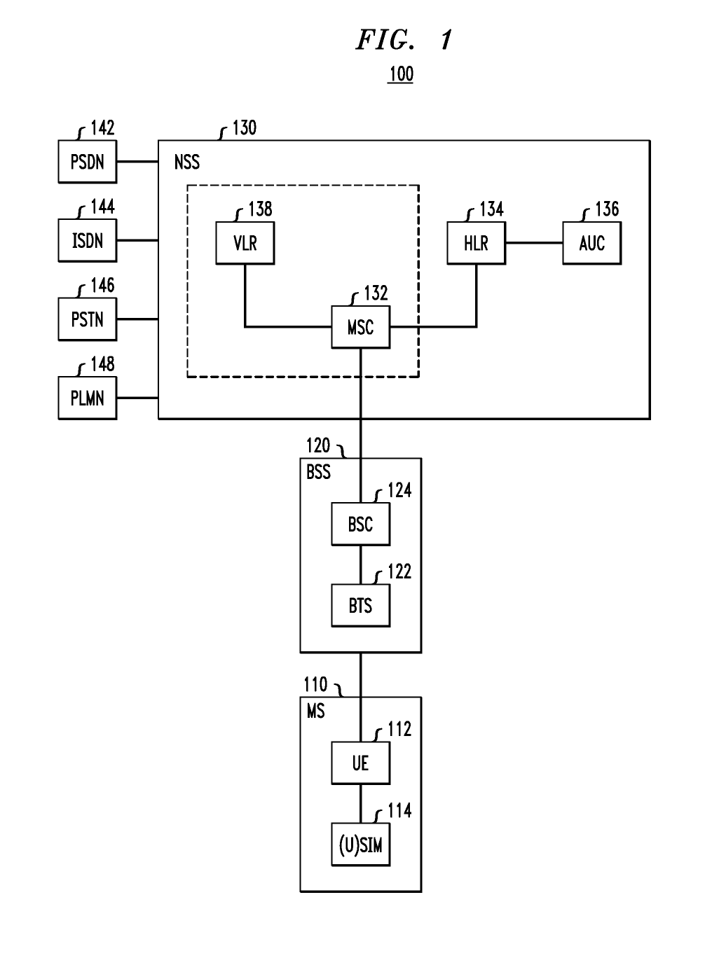

FIG. 1 illustrates a communication network architecture in which one or more embodiments of the invention may be implemented. In particular, FIG. 1 shows relevant parts of an illustrative GSM communication network (system) 100. It is assumed that the network architecture shown supports both GSM and UMTS communication modes.

As depicted, the communication network 100 includes a mobile station (MS) 110, a base station subsystem (BSS) 120, and a network and switching subsystem (NSS) 130. It is to be understood that the figure includes components of the network that are useful for an understanding of one or more embodiments of the invention. Thus, other components may be part of the network such as, but not limited to, an operation and support subsystem (OSS), additional mobile stations, additional base station subsystems and/or additional network support and switching subsystems.

The communication network 100 allows a user to communicate with one or more other networks and systems such as, but not limited to, a public switched data network (PSDN) 142, an integrated services digital network (ISDN) 144, a public switched telephone network (PSTN) 146 and a public land mobile network (PLMN) 148.

As further depicted in FIG. 1, the MS 110 includes user equipment (UE) 112 and a UMTS subscriber identity module (USIM) or a subscriber identity module (SIM) 114. The USIM or SIM contains respectively a unique international mobile subscriber identity (IMSI) that is used to identify the UMTS or GSM user of the MS to a network. Examples of a mobile station or user equipment may include, but are not limited to, a mobile or cellular (cell) telephone such as a so-called “smartphone,” a portable computer, a wireless email device, a personal digital assistant (PDA) or some other user mobile communication device.

The BSS 120 provides an interface between the MS 110 and the NSS 130, and includes a base transceiver station (BTS or base station) 122 and a base station controller (BSC) 124. The BTS 122 typically defines a cell area and serves as an access point to the network 100 through which MSs connect. The BTS may have multiple transceivers depending on the number of users in the given cell. In general, the BSC controls a group of BTSs and manages their radio resources.

The NSS 130 manages communication between one MS and another MS, and stores information about subscribers so as to, inter alia, manage their mobility. As depicted, the NSS 130 includes a mobile switching center (MSC) 132/a visiting location register (VLR) 138, a home location register (HLR) 134 and an authentication center (AUC) 136.

The MSC 132 provides switching functions to the communication network as well as connections to other networks and systems (e.g., PSDN 142, ISDN 144, PSTN 146 and PLMN 148). The HLR 134 stores information of subscribers belonging to the coverage area of the MSC including the current location of the subscribers and the services to which they have access. The VLR 138 stores information from a subscriber's HLR needed to provide the subscribed services to a visiting MS. Thus, the VLR 138 requests necessary information (including the authentication data) from the HLR of the visiting MS's home network when the MS enters the coverage area of MSC 132 so that requested service can be provided to the visiting MS. The AUC 136 provides security functions in the network 100 by providing information needed for authentication and encryption functions. Such information allows for verification of a subscriber's identity.

As mentioned above, other communication network components are typically utilized in providing the above-mentioned and other functions but are not shown in FIG. 1 for the sake of simplicity and clarity of understanding.

It is understood that in a GSM network, e.g., network 100 depicted in FIG. 1, GSM security algorithms are used to provide authentication and radio link privacy to users. GSM typically uses three different security algorithms called A3, A5, and A8. A3 and A8 are typically implemented together and thus known as A3/A8. An A3/A8 algorithm is used to authenticate the subscriber and generate a key for encrypting voice and data traffic. An A5 encryption algorithm scrambles the subscriber's voice and data traffic between the user equipment (UE) and the base station (BSS) to provide privacy.

3GPP Technical Specifications (TS) 43.020, 33.102, and 24.008 in 3GPP Release 9, the disclosures of which are incorporated by reference herein in their entirety, support a new GSM A5 encryption algorithm, referred to as A5/4, in an established UMTS security context. A5/4 requires a cipher (encryption) key that has a length (KLEN) of 128 bits, which is referred to as Kc128. The GSM A5/4 encryption algorithm is described in detail in 3GPP TS 55.226, the disclosure of which is incorporated by reference herein in its entirety.

In the above-referenced existing 3GPP standard, GSM encryption algorithm A5/4 applies to the UMTS security context only. The 3G authentication with authentication token AUTN is performed. 3GPP 24.008 reads as follows (“ME” being equivalent to “MS,” and “ciphering key” being equivalent to “cipher key”):

“4.3.2.3a 128-bit circuit-switched GSM ciphering key

The ME and the network may derive and store a 128-bit circuit-switched GSM ciphering key or GSM Kc128 from an established UMTS security context. If the GSM Kc128 exists, then it is also part of the UMTS security context.

The ME with a USIM in use shall compute a new GSM Kc128 using the UMTS ciphering key and the UMTS integrity key from an established UMTS security context as specified in 3GPP TS 33.102[5a]. The new GSM Kc128 shall be stored only in the ME. The ME shall overwrite the existing GSM Kc128 with the new GSM Kc128. The ME shall delete the GSM Kc128 at switch off, when the USIM is disabled as well as under the conditions identified in the subclause 4.1.2.2 and 4.3.2.4. The ME with a USIM in use shall apply the GSM Kc128 when in A/Gb mode an A5 ciphering algorithm that requires a 128-bit ciphering key is taken into use.

The network shall compute the GSM Kc128 using the UMTS integrity key and the UMTS ciphering key from an established UMTS security context as specified in 3GPP TS 33.102[5a] only when in A/Gb mode an A5 ciphering algorithm that requires a 128-bit ciphering key is to be used.”

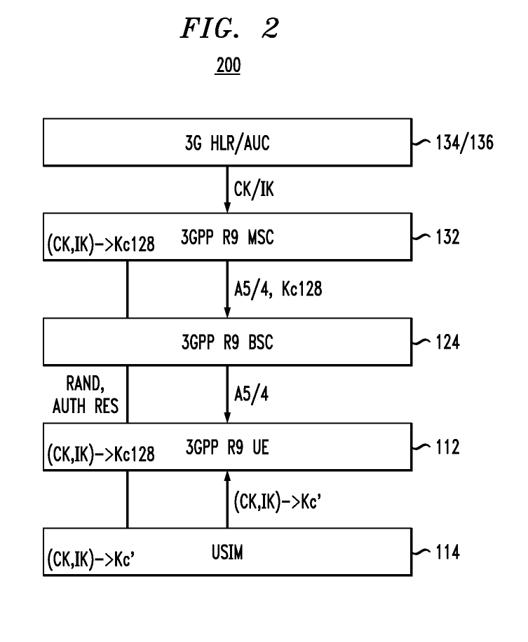

FIG. 2 illustrates a flow diagram of a methodology 200 for generating a cipher key in accordance with the A5/4 encryption algorithm with a UMTS security context. More particularly, FIG. 2 shows a relevant part of a cipher (encryption) key generation procedure 200 for when an MS enters the coverage area of a new MSC, i.e., the MS roams into a visiting network managed by the MSC, and the MS and the visiting network establish a cipher key. For example, assume that MS 110 in FIG. 1 enters the coverage area of the MSC 132 (with access being through BSS 120), and wishes to establish a cipher key with the network 100.

As shown in FIG. 2, the 3GPP HLR/AUC (134/136) sends the 3G authentication quintuplets (RAND, XRES, CK, IK, AUTN) to the 3GPP R9 MSC (132). That is, a authentication quintuplet or authentication vector (AV) includes a random challenge RAND, the corresponding authentication token AUTN, an expected authentication response XRES, an integrity key IK and a cipher (encryption) key CK. Note that the HLR does not send RES.

As further shown, the 3GPP R9 MSC (132) sends the authentication data RAND and AUTN to the 3G USIM (114) via the 3GPP R9 BSC (124) and the 3GPP R9 UE (112). The 3G USIM (114) generates CK, IK, RES and returns the RES to the 3GPP R9 MSC (132) via the 3GPP R9 UE (112) and the 3GPP R9 BSC (124). It is assumed that the RES matches the XRES stored in the 3GPP R9 MSC (132).

Next, the 3GPP R9 MSC (132) converts CK/IK to Kc128, as per the above-referenced 3GPP TS 55.226. The 3GPP R9 MSC (132) then sends the permission of encryption algorithm A5/4 with Kc128 to the 3GPP R9 BSC (124). The 3GPP R9 MSC (132) sends the chosen A5/4 to the 3GPP R9 UE (112). The 3GPP USIM (114) sends CK/IK to the 3GPP R9 UE (112). The 3GPP R9 UE (112) converts CK/IK to Kc128. The 3GPP R9 BSC (124) and the 3GPP R9 UE (112) then use Kc128 to perform the encryption on the 2G radio interface established there between.

Note that the prime symbol, as used herein, on any key symbol indicates that the key is converted from one or more other keys. Thus, by way of example, Kc′ is converted from CK and IK, and thus a prime symbol is used. It is to be appreciated that, whether a prime symbol is used or not, the description herein provides a detailed explanation for how each key is derived, computed and/or generated.

It is realized that there is no existing solution for GSM encryption algorithm A5/4 in the GSM security context. Advantageously, as will be explained in detail herein, illustrative embodiments of the invention provide solutions to use the GSM encryption algorithm A5/4 in the GSM security context. It is realized that embodiments of the invention will also be useful in the future for GSM encryption algorithms A5/5, A5/6, A5/7 and beyond in the GSM security context in order to make the communication in an established GSM security context more secure. Embodiments of the invention also apply to the computation of GPRS GSM Kc128 for the GPRS encryption algorithms.

Thus, as explained above, a 128-bit cipher key Kc128 is required for encryption algorithm A5/4 in the UMTS security context. In contrast, it is realized that a 64-bit cipher key, referred to as Kc64 or Kc or Kc′ (Kc and Kc′ are the standard terms for the 64-bit cipher key while Kc64 is more descriptive), is presented in the GSM security context. Embodiments of the invention provide techniques for deriving the cipher key Kc128 from the cipher key Kc64 in the GSM security context.

For example, one illustrative approach of the invention provides a two-step key conversion methodology. In the two-step conversion, as will be explained in detail below, the methodology converts the cipher key Kc64 to CK′ and IK′ and then to Kc128.

In another illustrative approach of the invention, a one-step key conversion methodology is provided. In this methodology, the cipher key Kc128 is generated as a repetition of the cipher key Kc64. That is, Kc128=Kc64∥Kc64. Kc128 is generated by concatenating one instance of Kc64 to another instance of Kc64.

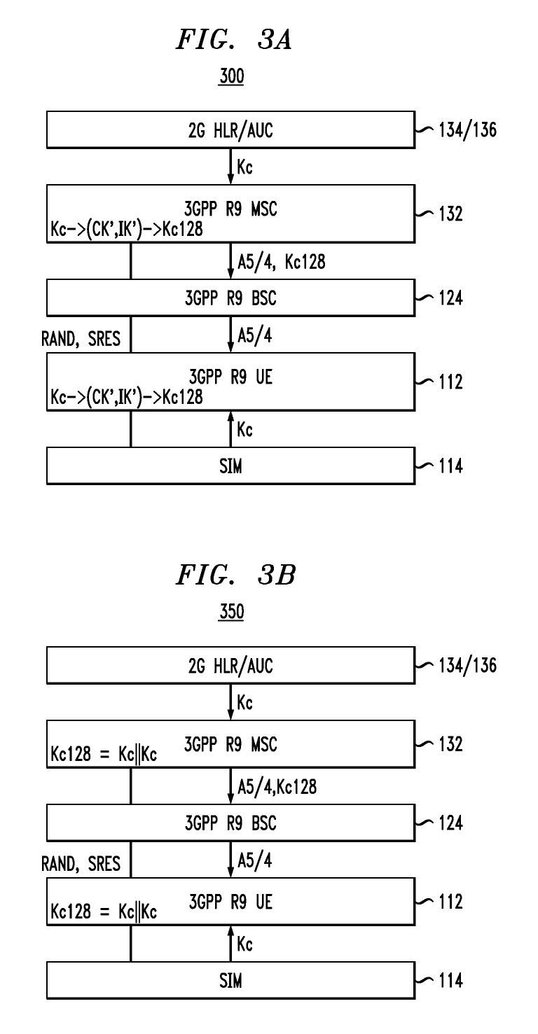

Below, we first describe the two-step and one-step key conversions in the context of the GSM network components in FIG. 1 (reference numerals from FIG. 1 are given in parentheses). We then provide illustrative descriptions of how each conversion methodology may be applied in various illustrative network scenarios in the context of FIGS. 3A through 6.

### Two-step Key Conversion (Generation)

On MSC/VLR (132/138):

If (CK, IK) is received from the HLR (134) or from the previous VLR, the (new) VLR (138) performs the derivation: (CK, IK)->Kc128. 3G authentication with AUTN is performed.

If Kc64 is received from the HLR (134) or from the previous VLR, the (new) VLR performs the derivations: Kc64->(CK′, IK′)->Kc128. 2G authentication without AUTN is performed.

On the UE (112):

If 3G authentication with AUTN is performed, the UE (112) performs the derivation: (CK, IK)->Kc128.

If 2G authentication without AUTN is performed and a USIM (114) is inserted in the UE (112), the USIM converts (CK, IK) to Kc′ and the UE performs the derivations Kc′->(CK′, IK′)->Kc128.

If 2G authentication without AUTN is performed and SIM (114) is inserted in the UE (112), the UE performs the derivations Kc->(CK′, IK′)->Kc128. 2G authentication may be performed via a previous RNC (radio network controller—not expressly shown in FIG. 1) and authentication is skipped via the BSC (124).

When the BSC (124) chooses encryption algorithm A5/4, if only Kc64, without (CK, IK), is received from the (U)SIM (114), then the UE (112) computes Kc128 from Kc64. This is the case of 2G authentication without AUTN. In this case, (CK, IK) is not available in the MSC (132) and the MSC computes Kc128 from Kc64.

When the BSC (124) chooses A5/4, if (CK, IK) and Kc64′ (where Kc64′ is derived from (CK, IK)) are received from the USIM (114), the UE (112) derives Kc128 from (CK, IK) instead of Kc64′->(CK′, IK′)->Kc128. This is the case of 3G authentication with AUTN. In this case, (CK, IK) is available in the MSC (132) and the MSC derives Kc128 from (CK, IK).

In the case that the GSM security context has been established, during the HSPA-SRVCC (High Speed Packet Access-Single Radio Voice Call Continuity) call, the UE (112) derives Kc64′ from the Kc64 and the NONCE. When the BSC (124) chooses A5/4, the UE (112) computes Kc128 from Kc64′. In this case, the SGSN (serving GPRS support node—not expressly shown in FIG. 1) derives Kc64′ from the Kc64 and the NONCE, and transfers Kc64′ to the MSC (132). The MSC then computes Kc128 from Kc64′.

To compute Kc128 from Kc64, Kc64->(CK, IK) is performed first, followed by (CK, IK)->Kc128.

The computation of Kc64->(CK, IK) is specified in section 6.8.2.3 in 3GPP 33.102, the disclosure of which is incorporated by reference herein. The computation of (CK, IK)->Kc128 is specified in Annex B.5 of 3GPP 33.102.

### One-Step Key Conversion (Generation)

On MSC/VLR (132/138):

If (CK, IK) is received from the HLR (or from the previous VLR), the (new) VLR (138) performs the derivation: (CK, IK)->Kc128. 3G authentication with AUTN is performed.

If Kc64 is received from the HLR (or from the previous VLR), the (new) VLR (138) performs the derivation Kc128=Kc64∥Kc64. 2G authentication without AUTN is performed.

On the UE (112):

If 3G authentication with AUTN is performed, the UE (112) performs the derivation: (CK, IK)->Kc128.

If 2G authentication without AUTN is performed and a USIM (114) is inserted in the UE (112), the USIM converts (CK, IK) to Kc64′ and the UE performs the derivation Kc128=Kc64′∥Kc64′.

If 2G authentication without AUTN is performed and a SIM (114) is inserted in the UE (112), the UE performs the derivation Kc128=Kc64∥Kc64. 2G authentication may be performed via a previous RNC and authentication is skipped via the BSC.

When the BSC (124) chooses A5/4, if only Kc64, without (CK, IK), is received from THE (U)SIM (114), the UE (112) computes Kc128=Kc64∥Kc64. This is the case of 2G authentication without AUTN. In this case, (CK, IK) is not available in the MSC (132) and the MSC computes Kc128=Kc64∥Kc64.

When the BSC (124) chooses A5/4, if (CK, IK) and Kc64′, where Kc64′ is derived from (CK, IK), are received from the USIM (114), the UE (112) derives Kc128 from (CK, IK) instead of Kc128=Kc64′∥Kc64′. This is the case of 3G authentication with AUTN. In this case, (CK, IK) is available in the MSC (132) and the MSC derives Kc128 from (CK, IK).

In the case that the GSM security context has been established, during the HSPA SRVCC call, the UE (112) derives Kc64′ from Kc64 and the NONCE. When the BSC (124) chooses A5/4, the UE (112) computes Kc128=Kc64′∥Kc64′. In this case, the SGSN derives Kc64′ from Kc64 and the NONCE, and transfers Kc64′ to the MSC (132). The MSC then computes Kc128=Kc64′∥Kc64′.

Given the detailed description of the illustrative methodologies for converting Kc64 to Kc128, we now provide illustrative descriptions of how each conversion methodology may be applied in various illustrative network scenarios in the context of FIGS. 3A through 6. In general, four illustrative cases are described:

1—For the 2G subscriber with a SIM, the MSC receives the 64-bit cipher key Kc64 in the authentication triplet from the HLR (FIGS. 3A and 3B).

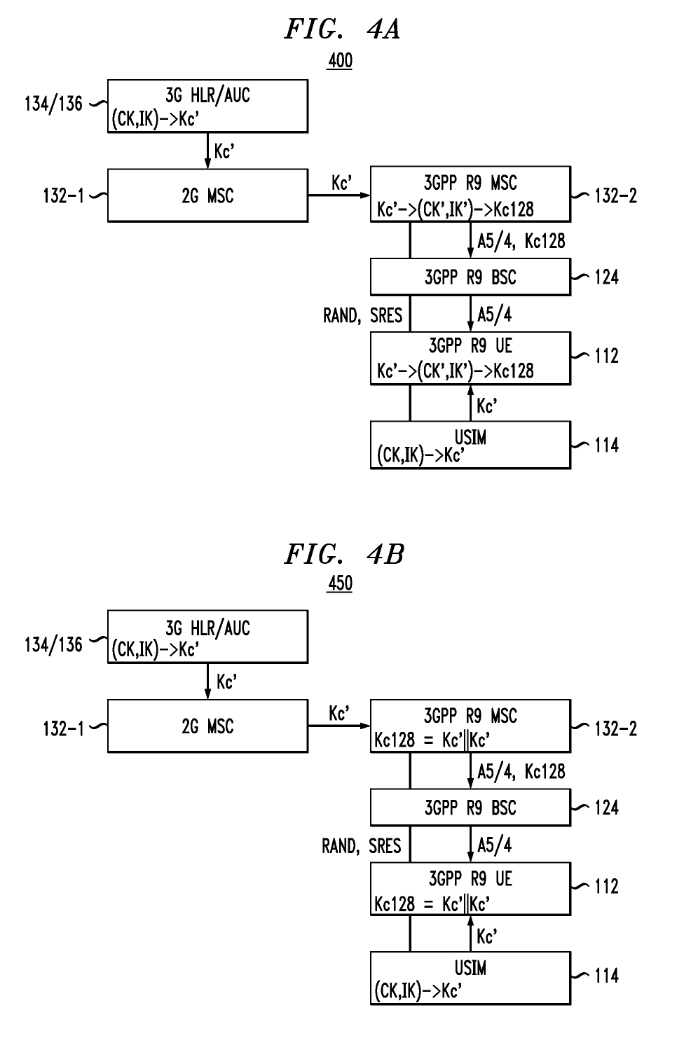

2—An A5/4 capable UE with a USIM performs an inter-VLR location update from a legacy 2G MSC (with the 64-bit Kc64 in MAP Send Identification Version 2) to the A5/4 capable MSC (FIGS. 4A and 4B).

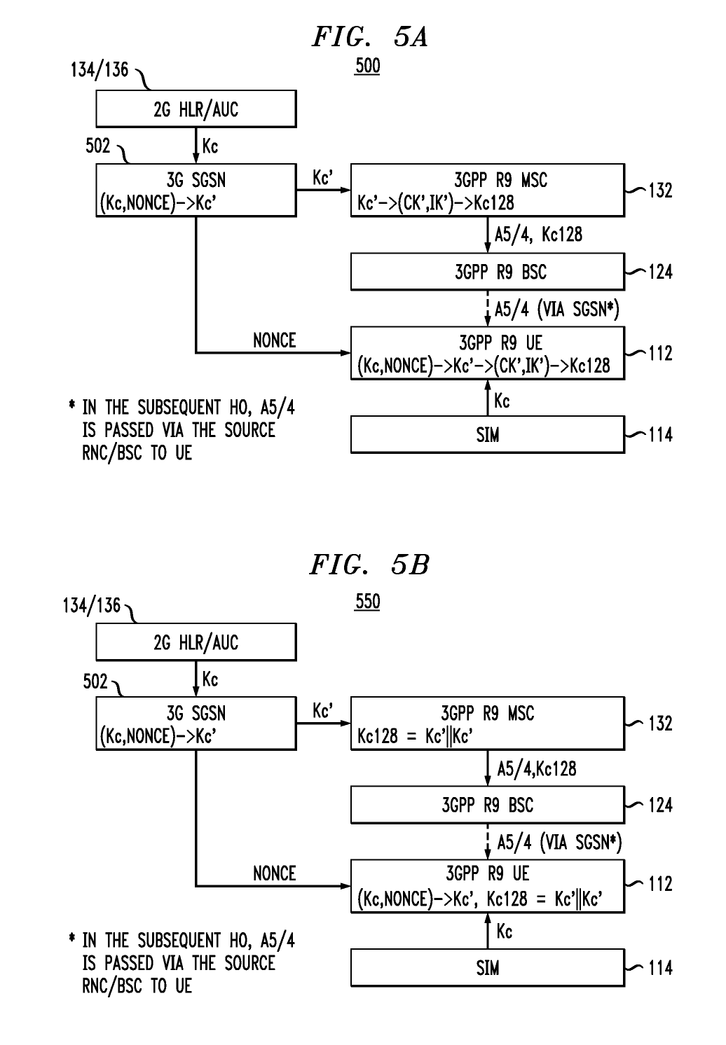

3—For HSPA SRVCC, the MSC receives the derived 64-bit Kc64′ for the 2G subscriber (FIGS. 5A and 5B).

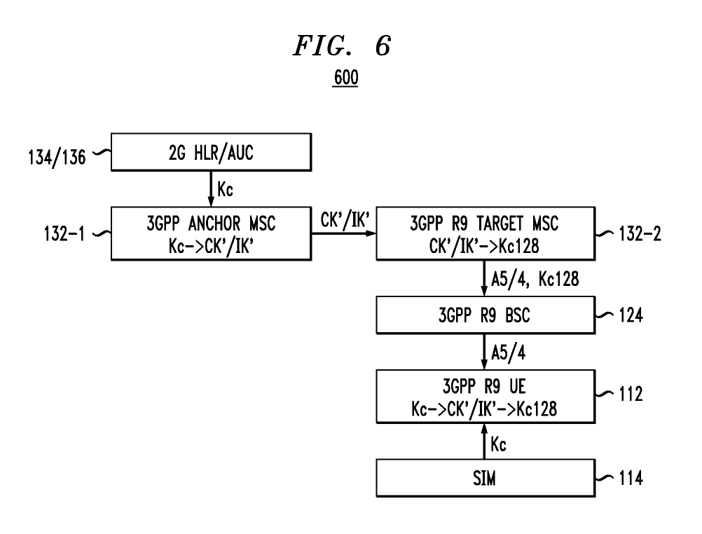

4—Inter-MSC handover case (FIG. 6).

Note that for the one-step key conversion (the interworking between 3G UTRAN access and 2G GERAN (GSM EDGE Radio Access Network) access), in the UMTS security context, Kc128 is derived from CK and IK. However, in the GSM security context, for the 3G UTRAN access and the handover to 3G UTRAN (or the HSPA SRVCC to 3G UTRAN), CK′ and IK′ are derived from Kc64 (or Kc64′ derived from Kc64 and the NONCE). In the case of the subsequent 2G GERAN access and the subsequent handover to 2G GERAN, the CK′ and IK′, if derived from Kc64 (or Kc64′), are not used to derive Kc128, as in Annex B.5 in 3GPP 33.102. Instead, the MSC and the UE compute Kc128=Kc64∥Kc64 (or Kc128=Kc64′∥Kc64′) or Kc128=CK′.

In this manner, embodiments of the invention provide, inter alia, a new GSM encryption algorithm A5/4 in an established GSM security context. It is realized that embodiments of the invention will also be useful in the future for GSM encryption algorithms A5/5, A5/6, A5/7 and beyond in the GSM security context in order to make the communication in an established GSM security context more secure.

FIG. 3A illustrates a flow diagram of a methodology 300 for generating a cipher key according to a first embodiment of the invention. This is a case using the two-step key conversion methodology where, for the 2G subscriber with a SIM, the MSC receives the 64-bit cipher key Kc64 in the authentication triplet from the HLR.

As shown, 2G HLR/AUC (134/136) sends the 2G authentication triplets (RAND, SRES, Kc) to 3GPP R9 MSC (132). The 3GPP R9 MSC sends the authentication data RAND via the 3GPP R9 UE (112) to the 2G SIM (114). The 2G SIM generates Kc, SRES and returns the SRES via the 3GPP R9 UE to the 3GPP R9 MSC. It is assumed that the SRES matches the one stored in the 3GPP R9 MSC (132). The 3GPP R9 MSC converts Kc to CK′/IK′ then to Kc128. The 3GPP R9 MSC sends the permission of A5/4 with Kc128 to the 3GPP R9 BSC (124). The 3GPP R9 MSC sends the chosen A5/4 to the 3GPP R9 UE. The 2G SIM sends Kc to the 3GPP R9 UE. The 3GPP R9 UE converts Kc to CK′/IK′ then to Kc128. The 3GPP R9 BSC and the 3GPP R9 UE use Kc128 to perform the encryption on the 2G radio interface.

FIG. 3B illustrates a flow diagram of a methodology 350 for generating a cipher key according to a second embodiment of the invention. This is a case using the one-step key conversion methodology where, for the 2G subscriber with a SIM, the MSC receives the 64-bit cipher key Kc64 in the authentication triplet from the HLR.

As shown, the 2G HLR/AUC (134/136) sends the 2G authentication triplets (RAND, SRES, Kc) to the 3GPP R9 MSC (132). The 3GPP R9 MSC sends the authentication data RAND via the 3GPP R9 UE (112) to the 2G SIM (114). The 2G SIM generates Kc, SRES and returns the SRES via the 3GPP R9 UE to the 3GPP R9 MSC. It is assumed that SRES matches. The 3GPP R9 MSC computes Kc128=Kc∥Kc. The 3GPP R9 MSC sends the permission of A5/4 with Kc128 to the 3GPP R9 BSC (124). The 3GPP R9 MSC sends the chosen A5/4 to 3GPP R9 UE. The 2G SIM sends Kc to the 3GPP R9 UE. The 3GPP R9 UE computes Kc128=Kc∥Kc. The 3GPP R9 BSC and 3GPP R9 UE use Kc128 to perform the encryption on the 2G radio interface.

FIG. 4A illustrates a flow diagram of a methodology 400 for generating a cipher key according to a third embodiment of the invention. This is a case using the two-step key conversion methodology where an A5/4 capable UE with a USIM performs an inter-VLR location update from a legacy 2G MSC (with the 64-bit Kc64 in MAP Send Identification Version 2) to the A5/4 capable 3GPP R9 MSC.

As shown, the 3G HLR/AUC (134/136) converts CK/IK to Kc′. The 3G HLR/AUC sends the 2G authentication triplets (RAND, SRES, Kc′) to a 2G MSC (denoted in FIG. 4A as 132-1). During the inter-VLR location update, the 2G MSC passes (RAND, SRES, Kc′) to the 3GPP R9 MSC (denoted in FIG. 4A as 132-2). The 3GPP R9 MSC sends the authentication data RAND via the 3GPP R9 UE (112) to the 3G USIM (114). The 3G USIM generates CK, IK, SRES and returns the SRES via the 3GPP R9 UE to the 3GPP R9 MSC. It is assumed that the SRES matches the one stored in the 3GPP R9 MSC. The 3GPP R9 MSC converts Kc′ to CK′/IK′ then to Kc128. The 3GPP R9 MSC sends the permission of A5/4 with Kc128 to the 3GPP R9 BSC (124). The 3GPP R9 BSC sends the chosen A5/4 to the 3GPP R9 UE. The 3G USIM converts CK/IK to Kc′. The 3G USIM sends Kc′ to the 3GPP R9 UE. The 3GPP R9 UE converts Kc′ to CK′/IK′ then to Kc128. The 3GPP R9 BSC and the 3GPP R9 UE use Kc128 to perform the encryption on the 2G radio interface.

FIG. 4B illustrates a flow diagram of a methodology 450 for generating a cipher key according to a fourth embodiment of the invention. This is a case using the one-step key conversion methodology where an A5/4 capable UE with a USIM performs an inter-VLR location update from a legacy 2G MSC (with the 64-bit Kc64 in MAP Send Identification Version 2) to the A5/4 capable MSC.

As shown, the 3G HLR/AUC (134/136) converts CK/IK to Kc′. The 3G HLR/AUC sends the 2G authentication triplets (RAND, SRES, Kc′) to the 2G MSC (132-1). During the inter-VLR location update, the 2G MSC passes (RAND, SRES, Kc′) to the 3GPP R9 MSC (132-2). The 3GPP R9 MSC sends the authentication data RAND via the 3GPP R9 UE (112) to the 3G USIM (114). The 3G USIM generates CK, IK, SRES and returns the SRES via the 3GPP R9 UE to the 3GPP R9 MSC. It is assumed that the SRES matches the one stored in the 3GPP R9 MSC. The 3GPP R9 MSC computes Kc128=Kc′∥Kc′. The 3GPP R9 MSC sends the permission of A5/4 with Kc128 to the 3GPP R9 BSC (124). The 3GPP R9 BSC sends the chosen A5/4 to the 3GPP R9 UE. The 3G USIM converts CK/IK to Kc′. The 3G USIM sends Kc′ to the 3GPP R9 UE. The 3GPP R9 UE computes Kc128=Kc′∥Kc′. The 3GPP R9 BSC (124) and the 3GPP R9 UE use Kc128 to perform the encryption on the 2G radio interface.

FIG. 5A illustrates a flow diagram of a methodology 500 for generating a cipher key according to a fifth embodiment of the invention. This is a case using the two-step key conversion methodology where, for HSPA SRVCC, the MSC receives the derived 64-bit Kc64′ for the 2G subscriber.

As shown, the 2G HLR/AUC (134/136) sends the 2G authentication triplets (RAND, SRES, Kc) to the 3G SGSN 502. During SRVCC, the 3G SGSN converts Kc and the NONCE to Kc′. The 3G SGSN passes Kc′ to the 3GPP R9 MSC (132). The 3GPP R9 MSC converts Kc′ to CK′/IK′ then to Kc128. The 3GPP R9 MSC sends the permission of A5/4 with Kc128 to the 3GPP R9 BSC (124). The 3GPP R9 MSC sends the chosen A5/4 via the 3G SGSN to the 3GPP R9 UE (112). The 3G SGSN passes the NONCE to the 3GPP R9 UE. The 2G SIM (114) sends Kc to the 3GPP R9 UE. The 3GPP R9 UE converts Kc and the NONCE to Kc′ and converts Kc′ to CK′/IK′ then to Kc128. The 3GPP R9 BSC and the 3GPP R9 UE use Kc128 to perform the encryption on the 2G radio interface.

FIG. 5B illustrates a flow diagram of a methodology 550 for generating a cipher key according to a sixth embodiment of the invention. This is a case using the one-step key conversion methodology where, for HSPA SRVCC, the MSC receives the derived 64-bit Kc64′ for the 2G subscriber.

As shown, the 2G HLR/AUC (134/136) sends the 2G authentication triplets (RAND, SRES, Kc) to the 3G SGSN (502). During SRVCC, the 3G SGSN converts Kc and the NONCE to Kc′. The 3G SGSN passes Kc′ to the 3GPP R9 MSC (132). The 3GPP R9 MSC computes Kc128=Kc′∥Kc′. The 3GPP R9 MSC sends the permission of A5/4 with Kc128 to the 3GPP R9 BSC (124). The 3GPP R9 MSC sends the chosen A5/4 via the 3G SGSN to the 3GPP R9 UE (112). The 3G SGSN passes the NONCE to the 3GPP R9 UE. The 2G SIM (114) sends Kc to the 3GPP R9 UE. The 3GPP R9 UE converts Kc and the NONCE to Kc′ and computes Kc128=Kc′∥Kc′. The 3GPP R9 BSC and the 3GPP R9 UE use Kc128 to perform the encryption on the 2G radio interface.

FIG. 6 illustrates a flow diagram of a methodology 600 for generating a cipher key according to a seventh embodiment of the invention. This is a case using the two-step key conversion methodology for the inter-MSC handover scenario.

As shown, the 2G HLR/AUC (134/136) sends the 2G authentication triplets (RAND, SRES, Kc) to the 3GPP anchor MSC (denoted in FIG. 6 as 132-1). After the authentication, the 3GPP anchor MSC converts Kc to CK′/IK′. During the inter-MSC handover, the 3GPP anchor MSC sends the permission of A5/4 with CK′/IK′ to the 3GPP R9 target MSC (denoted in FIG. 6 as 132-2). When the call is handed over to the BSC in the coverage of the 3GPP R9 target MSC, the 3GPP R9 target MSC converts CK′/IK′ to Kc128. The 3GPP R9 target MSC sends the permission of A5/4 with Kc128 to the 3GPP R9 BSC (124). The 3GPP R9 BSC sends the chosen A5/4 to the 3GPP R9 UE (112). The 2G SIM (114) sends Kc to the 3GPP R9 UE. The 3GPP R9 UE converts Kc to CK′/IK′ then to Kc128. The 3GPP R9 BSC and the 3GPP R9 UE use Kc128 to perform the encryption on the 2G radio interface.

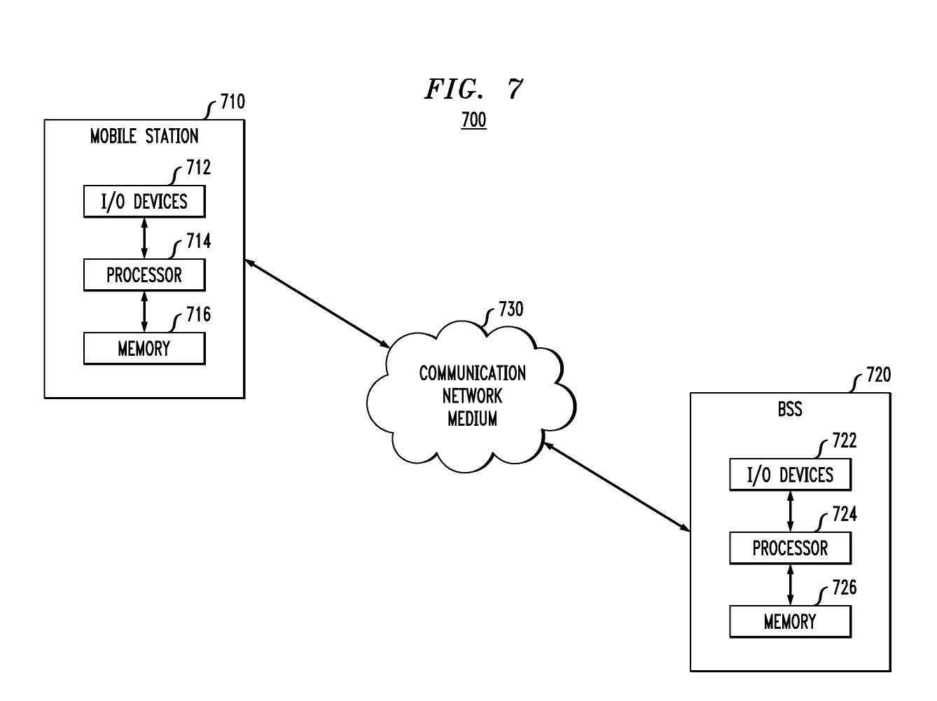

FIG. 7 illustrates a hardware architecture 700 of a part of a communication system and computing devices suitable for implementing one or more of the methodologies and protocols according to embodiments of the invention.

As shown, mobile station (MS) 710 (corresponding to MS 110 in FIG. 1, which includes UE 112 and (U)SIM 114) and base station subsystem 720 (corresponding to BSS 120 in FIG. 1, which includes BTS 122 and BSC 124) are operatively coupled via communication network medium 730. The network medium may be any network medium across which the MS and the base station are configured to communicate. By way of example, the network medium can carry IP packets and may involve any of the communication networks mentioned above. However, the invention is not limited to a particular type of network medium. Not expressly shown here, but understood to be operatively coupled to the network medium, the MS and/or the BSS, are the other network elements shown in or described in the context of FIGS. 1-6 (which can have the same processor/memory configuration described below).

As would be readily apparent to one of ordinary skill in the art, the elements may be implemented as programmed computers operating under control of computer program code. The computer program code would be stored in a computer (or processor) readable storage medium (e.g., a memory) and the code would be executed by a processor of the computer. Given this disclosure of the invention, one skilled in the art could readily produce appropriate computer program code in order to implement the protocols described herein.

Nonetheless, FIG. 7 generally illustrates an exemplary architecture for each device communicating over the network medium. As shown, MS 710 comprises I/O devices 712, processor 714, and memory 716. BSS 720 comprises I/O devices 722, processor 724, and memory 726.

It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM). In addition, the term “I/O devices” as used herein is intended to include one or more input devices (e.g., keyboard, mouse) for inputting data to the processing unit, as well as one or more output devices (e.g., CRT display) for providing results associated with the processing unit.

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU. That is, each computing device (710 and 720) shown in FIG. 7 may be individually programmed to perform their respective steps of the protocols and functions depicted in FIGS. 1 through 6. Also, it is to be understood that block 710 and block 720 may each be implemented via more than one discrete network node or computing device.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
generating a first cipher key of an encryption algorithm for use by at least one computing device in a communication network to exchange encrypted communications with at least another computing device in the communication network, the first cipher key being associated with a security context of a first communication mode and being generated from a second cipher key associated with a security context of a second communication mode, wherein the first cipher key is usable in the encryption algorithm in accordance with the second communication mode.

2. The method of claim 1, wherein the security context of the first communication mode is a Universal Mobile Telecommunications System (UMTS) security context.

3. The method of claim 1, wherein the security context of the second communication mode is a Global System for Mobile Communication (GSM) security context.

4. The method of claim 1, wherein the encryption algorithm is an encryption algorithm that utilizes a 128-bit cipher key.

5. The method of claim 1, wherein the first cipher key comprises a 128-bit cipher key.

6. The method of claim 1, wherein the second cipher key comprises a 64-bit cipher key.

7. The method of claim 1, wherein the generating step further comprises the at least one computing device:
obtaining the second cipher key;
generating a pair of key components from the second cipher key; and
generating the first cipher key from the pair of key components.

8. The method of claim 7, wherein the pair of key components comprise an integrity key (IK) and another cipher key (CK).

9. The method of claim 1, wherein the generating step further comprises the at least one computing device:
obtaining the second cipher key; and
generating the first cipher key by concatenating one instance of the second cipher key to another instance of the second cipher key.

10. The method of claim 1, wherein the at least one computing device generates the first cipher key.

11. The method of claim 10, wherein the at least one computing device comprises a mobile station in the communication network.

12. The method of claim 1, wherein another computing device in the communication network generates the first cipher key.

13. The method of claim 12, wherein the other computing device comprises a visiting location register.

14. The method of claim 12, wherein the other computing device comprises a mobile switching center.

15. The method of claim 1, wherein the second cipher key is derived from a nonce and a previously established cipher key that is equivalent to the second cipher key.

16. The method of claim 15, wherein the previously established cipher key that is equivalent to the second cipher key is generated as part of an authentication process.

17. The method of claim 16, wherein the previously established cipher key that is equivalent to the second cipher key is generated at a home location register.

18. An apparatus, comprising:
a memory associated with at least one computing device; and
a processor associated with the at least one computing device, coupled to the memory, and configured to generate a first cipher key of an encryption algorithm for use by the at least one computing device in a communication network to exchange encrypted communications with at least another computing device in the communication network, the first cipher key being associated with a security context of a first communication mode and being generated from a second cipher key associated with a security context of a second communication mode, wherein the first cipher key is usable in the encryption algorithm in accordance with the second communication mode.

19. The apparatus of claim 18, wherein the security context of the first communication mode is a Universal Mobile Telecommunications System (UMTS) security context.

20. The apparatus of claim 18, wherein the security context of the second communication mode is a Global System for Mobile Communication (GSM) security context.

21. The apparatus of claim 18, wherein the encryption algorithm is an encryption algorithm that utilizes a 128-bit cipher key.

22. The apparatus of claim 18, wherein the first cipher key comprises a 128-bit cipher key and the second cipher key comprises a 64-bit cipher key.

23. The apparatus of claim 18, wherein the generating step further comprises the processor:
obtaining the second cipher key;
generating a pair of key components from the second cipher key; and
generating the first cipher key from the pair of key components.

24. The apparatus of claim 18, wherein the generating step further comprises the processor:
obtaining the second cipher key; and
generating the first cipher key by concatenating one instance of the second cipher key to another instance of the second cipher key.

25. A computing device in a communication network, comprising:
a memory; and
a processor coupled to the memory and configured to generate a 128-bit cipher key of an encryption algorithm for use by the computing device to exchange encrypted communications with at least another computing device in the communication network, the 128-bit cipher key being associated with a Universal Mobile Telecommunications System (UMTS) security context and being generated from a 64-bit cipher key associated with a Global System for Mobile Communication (GSM) security context, wherein the 128-bit cipher key is usable in the encryption algorithm in accordance with a GSM communication mode.
